(19) United States
(12) Patent Application Publication
(10) Pub. No.: US 2009/0177743 A1
(43) Pub. Date: Jul. 9, 2009

(54) Device, Method and Computer Program Product for Cluster Based Conferencing

(76) Inventors: Gal Ashour, Yoqneam (IL); Akram Bitar, Kfar Peqiin (IL)

Correspondence Address: IBM CORPORATION, T.J. WATSON RESEARCH CENTER, P.O. BOX 218, YORKTOWN HEIGHTS, NY, 10598, US

(21) Appl. No.: 11/970,533

(22) Filed: Jan. 8, 2008

(51) Int. Cl. G06F 15/16

(52) U.S. Cl. 709/204

(57) ABSTRACT

A method and computer program product for conferencing, the method includes: electing a cluster leader node out of multiple nodes that participate in a conference; monitoring, by the cluster leader node and at least by one other node, a connectivity status of the nodes; recording conference content during at least a certain disconnection period of a certain node; and sending to the certain node, after the certain disconnection period ended, conference information representative of the recorded conference content.

### FIELD OF THE INVENTION

The present invention relates to a method, a device and a computer program product for cluster based conferencing.

### BACKGROUND OF THE INVENTION

Conference applications enable multiple users to participate in a conference and exchange conference content. During instant messaging conferences users can exchange textual information as well as send files to each other.

Conferences are susceptible to communication and other faults. A user can disconnect from a conference due to these errors. When that user re-joins the conference he already missed some conference content. In some cases a user will voluntarily disconnect from the conference. In both case the user will not receive conference content exchanged during his disconnection period.

There is a growing need to provide conferencing methods, systems and computer program products that will allow a user to receive conference content exchanged during his disconnection period.

### SUMMARY OF THE PRESENT INVENTION

A method and computer program product for conferencing, the method includes: electing a cluster leader node out of multiple nodes that participate in a conference; monitoring, by the cluster leader node and at least by one other node, a connectivity status of the nodes; recording conference content during at least a certain disconnection period of a certain node; and sending to the certain node, after the certain disconnection period ended, conference information representative of the recorded conference content.

### BRIEF DESCRIPTION OF THE DRAWINGS

The present invention will be understood and appreciated more fully from the following detailed description taken in conjunction with the drawings in which:

FIG. 1 illustrates multiple devices and their environment according to an embodiment of the invention;

FIG. 2 is a flow chart of a method for cluster based conferencing according to an embodiment of the invention; and

FIG. 3 is a flow chart of a method for cluster based conferencing according to another embodiment of the invention.

### DETAILED DESCRIPTION OF THE DRAWINGS

The term “conference content” as used in this specification means information sent from one node to the other during a conference. The information can include textual information, video information, auditory information and the like. Files that are sent from one node to another during the conference can also be regarded as conference content. A portion of a conference content can include conference content sent from a certain node, conference content received by a certain node (as the primary recipient), conference content exchanged during a certain time period, conference content of a certain type (for example—only text, only video, only attached files). According to an embodiment of the invention conference content can include information sent during a conference that differs from an instant messaging conference. For example it can include content exchanged during a phones conference.

The present invention provides a method, a device and a computer program product for cluster based conferencing. Nodes that form the cluster can participate in a conference such as an instant massage conference. The nodes elect a cluster leader node that can detect nodes disconnections, participate in a recording of conference content exchanged during a disconnection period of each of the disconnected nodes and finally send the recorded conference content to a previously disconnected node.

A disconnection period of a node is the time period during which that node was disconnected. The disconnection period can start when that node disconnects from a conference (or when the disconnection is detected) and ends when that node rejoins the conference or when the conference ends. The disconnection period can start by a voluntary disconnection or by a non-voluntary disconnection.

A connectivity status can indicate whether a node is connected or disconnected. It can also indicate whether the node is connected but experiences some connectively errors.

The connectivity status of the cluster leader node as well as the connectivity status of the other nodes is monitored such as enable a recovery from a disconnection of the cluster leader node and from a disconnection of nodes that differ from the cluster leader nodes.

Conveniently, the cluster based conferencing provides a highly reliable conferencing scheme. By distributing the monitoring, recording and conference content provision tasks among multiple nodes the conferencing can be reliable (able to recover from disconnections including cluster leader node disconnections), and prevents a single device form becoming a bottleneck of communication or memory resources. A node can temporarily store conference content (including attached files exchanged during the conference) and erase the content once the conference ends, thus improving storage resources allocation. It is noted that some instant messaging applications like Sametime™ of IBM, has an option to log the history of a conference. Such a log can be utilized by the clustering based mechanism.

Conveniently, if a node is disconnected but rejoins the conference before the conference ends it can receive conference content that was exchanged during the disconnection period of that node. It can also receive conference content that was exchanged even while the node was connected. It is noted that the update can be performed by using communication channels that are open even when the conference ends. For example—the update can involve sending an email to the node.

Conveniently, if a node was disconnected and did not rejoin the conference before the conference ended he still can receive conference content after the conference ends. A node can indicate before performing a voluntary disconnection that it wishes to receive conference content. The conference content (usually the conference content exchanged after the voluntary departure) can be sent to that node.

Conveniently, the cluster leader node is responsible for: (i) handling cluster memberships (adding new nodes to the cluster, removing nodes from the cluster); (ii) monitoring the connectivity status of the nodes of the cluster and detecting disconnected, reconnected and newly joined nodes; (iii) recording (for example logging) conference content; (iv) updating a disconnected node once it joins the conference again (once its disconnection period ends) with conference content that were exchanged during the disconnection period of that node; (v) updating nodes (even nodes that were not disconnected during the conference) about conference content (such as by sending a message that includes the whole conference content, a summary of the conference content or a portion of the conference content.

It is noted that the conference content (and especially a summary of the conference content) can be sent to one or more nodes, including nodes that were not disconnected during the conference call. A node can receive conference content that was exchanged during its disconnection period but this is not necessarily so. A node can, for example, receive conference content exchanged during one or more periods during which that node was connected and even receive the entire conference content.

If a node received conference content that exceeds the conference content exchanged during the node disconnection period that the conference content exchanged during the disconnection period can be highlighted, emphasized or otherwise provided in a manner that differs from other received conference content. For example different fonts, different colors, adding annotation text and the like.

Conveniently, the summary can include metadata that reflects the participation of different nodes in the conference. The metadata can indicate when users were disconnected, thus easing a correlation between content and nodes (users) that participated in the conference.

Conveniently, the cluster nodes elect a cluster leader node and communicate with each other by applying well known clustering method. Sample clustering methods are illustrated in: (i) L. Lamport. “The part-time parliament”. Technical Report 49, Systems Research Center, Digital Equipment Corp., Palo Alto, September 1989 and Butler W. Lampson, “How to Build a Highly Available System Using Consensus” (1996). See: http://research.microsoft.com/lampson/58-Consensus/Acrobat.pdf.

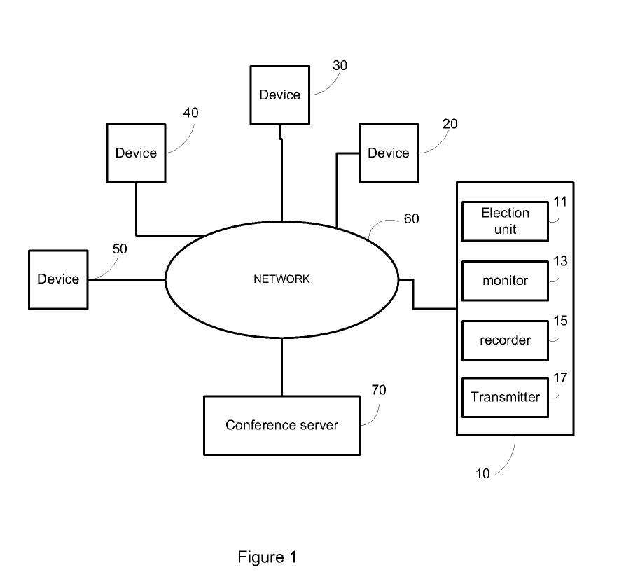

FIG. 1 illustrates multiple devices 10, 20, 30, 40 and 50 for cluster based conferencing and their environment according to an embodiment of the invention.

These devices are connected to network 60 and to a conference system such as conference server 70.

Devices 10, 20, 30, 40 and 50 can form a cluster. The cluster is defined by the nodes that participate in a conference. Thus, assuming that each device of devices 10, 20, 30, 40 and 50 intend to participate in a certain conference they form a cluster. At every given point in time of the conference one of these nodes acts as a cluster leader node.

Each device includes software, hardware, middleware or firmware or a combination thereof. For simplicity of explanation only the inner entities of device 10 are shown.

Device 10 is illustrated as including election unit 11, monitor 13, recorder 15 and transmitter 17.

Election unit 11 participates in an election of a cluster leader node out of multiple nodes that participate in a conference. Election unit 11 can also participate in an election of one or more replacement cluster leader node. Monitor 13 monitors a connectivity status of the nodes. Recorder 15 that is adapted to record conference content during at least a certain disconnection period of a certain node. Transmitter 17 sends to the certain node conference information representative of the recorded conference content after the certain disconnection period ended.

Conveniently, the election units of devices 10, 20, 30, 40 and 50 participate in a distributed election algorithm that elects a cluster leader node.

The election of the cluster leader node can be executed when the conference is initiated.

According to an embodiment of the invention a replacement cluster leader node is also elected by the nodes of the cluster. The replacement cluster leader node can be elected in response to a disconnection of the cluster leader node but this is not necessarily so. For example, the replacement cluster leader node can be elected when the conference starts or at another (conveniently predefined) time that precedes the disconnection of the cluster leader node.

The election of the replacement cluster leader node can be executed in timing proximity to the election of the cluster leader, but this is not necessarily so. The election of the replacement cluster leader can be executed when the conference is initiated

It is noted that more that one replacement cluster header node can be elected.

The election units of the devices 10, 20, 30, 40 and 50 can apply one or more election algorithms. For example, the election can be based upon heuristics, arbitrary, can be semi-random, random or can be deterministic.

Yet for another example, the election can be responsive to a location of the nodes. The election can be responsive to one or more node characteristics. These characteristics can include the node reliability. The reliability can be obtained by monitoring disconnection history, communication errors that did not result in disconnection of the node and the like.

According to an embodiment of the invention the election can be responsive to an order of node conference joining events and node conference initiating event. Thus, the node that initiates the conference can have the highest election probability. The first node that joined the conference can have a lower election probability and the like. It is noted that the election can include electing the node that initiated the conference to be the cluster leader node while electing the first joining node as a replacement cluster leader node. Yet for another example the order of joining the conference can be just one parameter that is fed to the algorithm and other parameters can be taken into account. Those of skill in the art will appreciate that the nodes that participate in a conference can be identified by other methods.

Conveniently, the election is also responsive to redundancy parameters. For example, the election algorithm can prefer to elect a replacement cluster leader node that is located at a different location (or connected via different communication channels) than the cluster leader node.

Monitor 13 can monitor the connectively status of other nodes (such as devices 20, 30, 40 and 50) by applying one or more well known monitoring schemes. It is noted that according to various embodiment of the invention monitor 13 can monitor all other nodes, can monitor only some nodes or even just one other node. Conveniently, the leader cluster node informs monitor 13 about which nodes to monitor. If the leader cluster node is device 10 it can order monitor 13 to monitor one or more nodes and also instruct monitors of other nodes to monitor one or more nodes.

Conveniently, more than one node monitors the state of other nodes in order to prevent monitoring breakdown once the monitoring node fails to operate or becomes disconnected.

There are various methods for monitoring connectivity status and especially detecting lost network connectivity or detecting that a node has been disconnected for whatever reason and is no longer online or participating. It is noted that some conference applications (such as instant messaging and web-conferencing) are equipped with monitoring capabilities. Other techniques may include sending a periodic “heartbeat” or “I am alive” message or signal by the nodes of the cluster. Alternatively, the cluster leader node may periodically poll the nodes. The cluster leader node can also instruct another node to perform the polling or a part of the polling. Accordingly, a disconnected node (that is monitored by monitor 13) may be identified or determined when monitor 13 does not receive a return signal indicating that the node is still connected.

Monitor 13 can also detect information that indicates that a node has requested to voluntarily leave the conference. A user that utilizes the node can generate such a request in various manners, including but not limited to closing a web-conference window or by explicitly clicking on a button in the meeting client's graphical user interface (GUI). The request can be sent to the nodes but can also be sent to another entity (such as an instant messaging server) and be intercepted by monitor 13. Additionally or alternatively, the other entity can be configured to send an indication about the request to one or more nodes of the cluster.

It is noted that a node can request from the cluster leader node to receive conference content even though he (the requesting node) voluntarily disconnected. Such a request can be responded (at least partially by the cluster leader node) even after the conference ends, for example by sending to this requesting node a representation of conference content exchanged during at least a portion of the conference.

Recorder 15 records conference content or a portion of the conference content. Recorder 15 can be instructed by the cluster leader node to record conference content (or a portion thereof) to stop recording the conference content (or a portion thereof), to provide the recorded conference content (or a portion thereof) to the transmitter, to delete recorded conference content (or a portion thereof). Device 10 can also be instructed to compress the recorded conference content (or a portion thereof) or to generate a representation of the conference content (or a portion thereof). The representation can be, for example, a textual representation of speech signals sent from node to the other.

Recorder 15 can be instructed to record conference content during a disconnection period of a certain node but this is not necessarily so. For example, recorder 15 can record conference content regardless of the connectivity status of other nodes, It can, for example, record all the conference content or conference content exchanged during a certain time period. Conveniently, recorder 15 records all conference content but can record only content sent from a specific node.

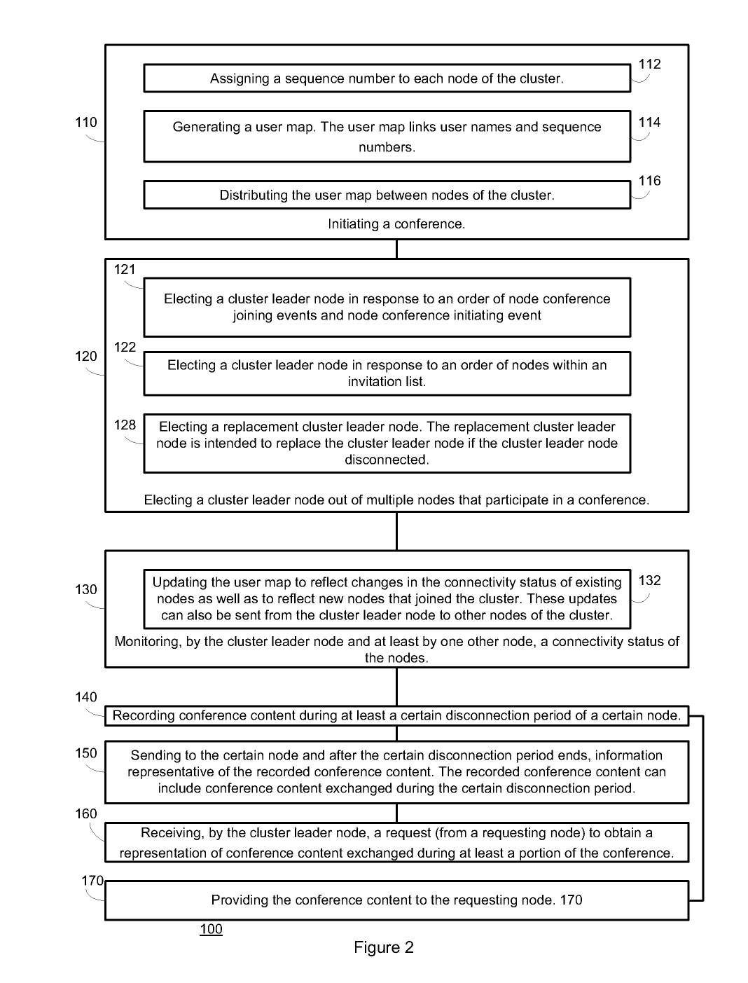

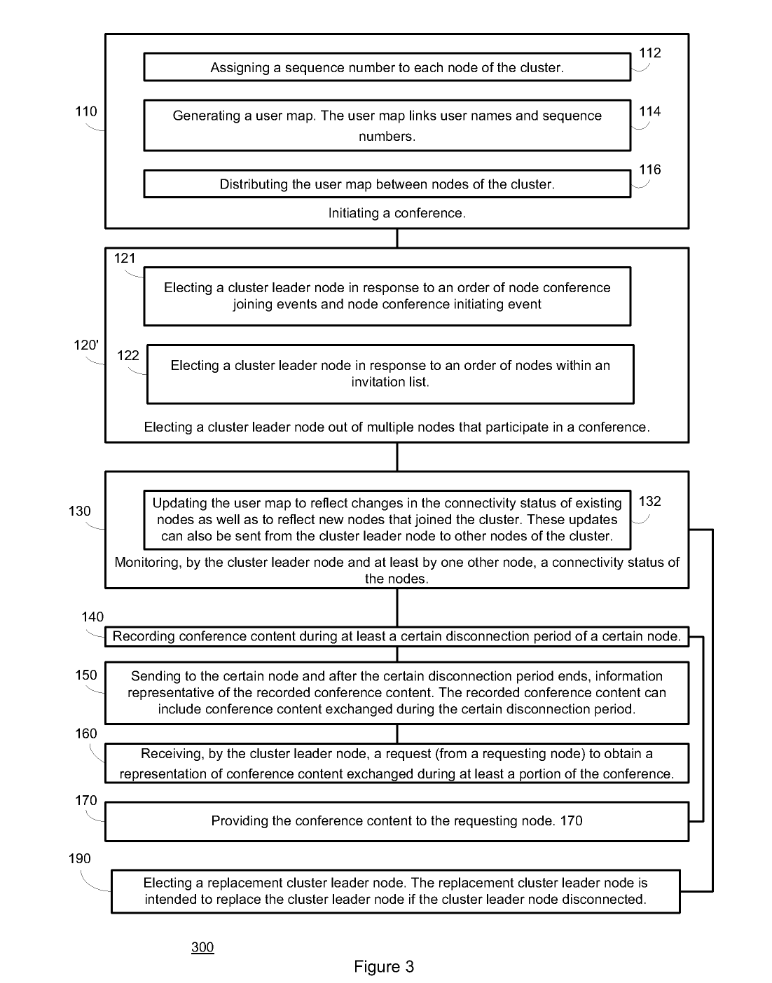

FIGS. 2 and 3 illustrate methods 100 and 200 for cluster based conferencing according to various embodiments of the invention.

Method 100 starts by stage 110 of initiating a conference. This stage can include sending an invitation (by one node) to multiple nodes to initiate a conference and receiving join messages (or other acknowledgments) from other nodes. The conference can be an instant messaging conference but this is not necessarily so. It can also be a voice over data infrastructure (such as Internet Protocol) conference.

Stage 110 can include stages 112, 114 and 116. Stage 112 includes assigning a sequence number to each node of the cluster. A node can be identified by its user name and its sequence number. Conveniently, a node that establishes the conference can be identified by the lowest (or highest) sequence number value (for example zero). Stage 112 can include assigning sequence numbers to nodes in response to their order in an invitation list, and additionally or alternatively in response to the order in which they joined the conference.

Conveniently, a user that disconnects and then rejoins the conference receives the same sequence number as he had before the disconnection period.

Stage 112 is followed by stage 114 of generating a user map. The user map links user names and sequence numbers. It is noted that if one or more new users join the conference after the user map was generated then the user map will be updated accordingly.

Stage 114 is followed by stage 116 of distributing the user map between nodes of the cluster.

Stage 110 is followed by stage 120 of electing a cluster leader node out of multiple nodes that participate in a conference. The election is made by multiple nodes of the cluster according to various elections algorithms, some of which were mentioned above.

Stage 120 conveniently includes at least one of the following stage or a combination thereof: (i) stage 121 of electing a cluster leader node in response to an order of node conference joining events and node conference initiating event; (ii) stage 122 of electing a cluster leader node in response to an order of nodes within an invitation list; (iii) stage 128 of electing a replacement cluster leader node. The replacement cluster leader node is intended to replace the cluster leader node if the cluster leader node disconnected. Stage 120 can also include updating the nodes defining who is the cluster leader node. The update can be performed by the cluster leader node but this is not necessarily so.

Stage 120 is followed by stage 130 of monitoring, by the cluster leader node and at least by one other node, a connectivity status of the nodes.

Stage 130 can include stage 132 of updating the user map to reflect changes in the connectivity status of existing nodes as well as to reflect new nodes that joined the cluster. These updates can also be sent from the cluster leader node to other nodes of the cluster.

Stage 130 is illustrated in FIG. 2 as being followed by stage 140 of recording conference content during at least a certain disconnection period of a certain node.

Stage 140 can involve generating, by the cluster leader node, conference content recording commands and sending the conference content recording commands to one or more nodes. It is noted that stages 130 and 140 can be executed in parallel to each other, as well as in parallel to other stages of method 100 (such as stage 150 and 160).

It is noted that stage 140 can include recording conference content regardless of a disconnection of a node. Nodes can record all the conference content or predefined conference content portions. It is noted that a retrieval of conference content exchanged during a disconnection period can involve retrieving recorded conference content from one or more nodes.

Conveniently, stage 140 can include recording conference content and marking disconnection and reconnection events. These markings can be used for retrieval of information to be sent to a previously disconnected node.

Stage 140 is followed by stage 150 of sending to the certain node and after the certain disconnection period ends, information representative of the recorded conference content. The recorded conference content can include conference content exchanged during the certain disconnection period.

It is noted that if a node disconnected stage 150 can involve sending to the node information representative of the conference content exchanged during its disconnection period. It is noted that stage 150 can also involve sending to the certain node additional information. For example, that node can receive a representation of conference content recoded during a certain recording period. The certain recording period can exceed the certain disconnection period (thus include more conference content) and marking the representation of conference content recorded during the certain disconnection period.

Method 100 further includes stage 160 of receiving, by the cluster leader node, a request (from a requesting node) to obtain a representation of conference content exchanged during at least a portion of the conference. Stage 160 is followed by stage 140. Stage 140 is followed by stage 170 of providing the conference content to the requesting node.

Stage 130 can also include detecting that the conference ended. The conference end can be detected when a predefined timing condition was fulfilled or when only a single node remains connected. If the end of the conference call is detected various stages can be executed. These stages can include stage 170 or stage 180 of sending conference content, conference content portion or a conference content summary to one or more nodes of the cluster.

Method 200 of FIG. 3 differs from method 100 of FIG. 2 by the manner in which the replacement leader node is elected. Stage 120 of method 100 includes stage 128 of electing the replacement cluster leader node while stage 120′ of method 200 does not include such a stage. On the other hand method 200 includes stage 190 of electing a replacement cluster leader node if the cluster leader node has disconnected. Stage 190 is followed by stage 130.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Conveniently, a computer program product is provided. The computer program product includes a computer usable medium that includes a computer readable program, wherein the computer readable program when executed on a computer causes the computer to: receive from a first user a definition of an alert to be generated in response to an availability of a second user to participate in an instant messaging session; and send to the second user an alert indication indicative of the alert.

The computer readable program can cause the computer to execute one or more states of any method out of methods 100 and 200.

Variations, modifications, and other implementations of what is described herein will occur to those of ordinary skill in the art without departing from the spirit and the scope of the invention as claimed.

Accordingly, the invention is to be defined not by the preceding illustrative description but instead by the spirit and scope of the following claims.

We claim:

1. A method for conferencing, the method comprising:
electing a cluster leader node out of multiple nodes that participate in a conference;
monitoring, by the cluster leader node and at least by one other node, a connectivity status of the nodes;
recording conference content during at least a certain disconnection period of a certain node; and
sending to the certain node, after the certain disconnection period ended, conference information representative of the recorded conference content.

2. The method according to claim 1 wherein the electing comprises electing a replacement cluster leader node; wherein the replacement cluster leader node is intended to replace the cluster leader node if the cluster leader node disconnected.

3. The method according to claim 1 comprising electing a replacement cluster leader node if the cluster leader node has disconnected.

4. The method according to claim 1 comprising receiving, by the cluster leader node, a request from a requesting node to obtain a conference content exchanged during at least a portion of the conference; and provide the conference content to the requesting node.

5. The method according to claim 1 wherein the electing comprises electing a cluster leader node in response to an order of node conference joining events and node conference initiating event.

6. The method according to claim 1 comprising generating, by the cluster leader node, conference content recording commands and sending the conference content recording commands to at least two nodes.

7. The method according to claim 1 wherein the conference is an instant messaging conference.

8. The method according to claim 1 comprising sending to the certain node a conference content recoded during a certain recording period; wherein the certain recording period exceeds the certain disconnection period and marking the conference content recorded during the certain disconnection period.

9. A computer program product comprising a computer usable medium including a computer readable program, wherein the computer readable program when executed on a computer causes the computer to: elect a cluster leader node out of multiple nodes that participate in a conference; monitor, by the cluster leader node and at least by one other node, a connectivity status of the nodes; record conference content during at least a certain disconnection period of a certain node; and send to the certain node, after the certain disconnection period ended, conference information representative of the recorded conference content.

10. The computer program product according to claim 9, wherein the computer readable program when executed on a computer causes the computer to elect a replacement cluster leader node; wherein the replacement cluster leader node is intended to replace the cluster leader node if the cluster leader node disconnected.

11. The computer program product according to claim 9, wherein the computer readable program when executed on a computer causes the computer to elect a replacement cluster leader node if the cluster leader node has disconnected.

12. The computer program product according to claim 9, wherein the computer readable program when executed on a computer causes the computer to receive a request from a requesting node to obtain a conference content exchanged during at least a portion of the conference; and provide the conference content to the requesting node.

13. The computer program product according to claim 9, wherein the computer readable program when executed on a computer causes the computer to elect a cluster leader node in response to an order of node conference joining events and node conference initiating event.

14. The computer program product according to claim 9, wherein the computer readable program when executed on a computer causes the computer to generate conference content recording commands and send the conference content recording commands to at least two nodes.

15. The computer program product according to claim 9, wherein the computer readable program when executed on a computer causes the computer to participate in an instant messaging conference.

16. The computer program product according to claim 9, wherein the computer readable program when executed on a computer causes the computer to send to the certain node a conference content recoded during a certain recording period; wherein the certain recording period exceeds the certain disconnection period and marking the conference content recorded during the certain disconnection period.

17. A device for providing an alert indication, the device comprising: an election unit adapted to participate in an election of a cluster leader node out of multiple nodes that participate in a conference; a monitor that monitors a connectivity status of the nodes; a recorder adapted to record conference content during at least a certain disconnection period of a certain node; and a transmitter adapted to send to the certain node, after the certain disconnection period ended, conference information representative of the recorded conference content.

18. The device according to claim 17 wherein the election unit is adapted to participate in an election of a replacement cluster leader node; wherein the election of the replacement cluster leader node occurs in response to a disconnection of the cluster leader node or occurs in timing proximity to the election of the cluster leader node.

19. The device according to claim 17 wherein the recorder is responsive to content recording commands sent by the cluster leader node to at least two nodes.

20. The device according to claim 17 wherein the election unit is adapted to participate in an election of a cluster leader node in response to an order of node conference joining events and node conference initiating event.
